(19) United States
(12) Patent Application Publication
(10) Pub. No.: US 2012/0005033 A1
(43) Pub. Date: Jan. 5, 2012

(54) Anonymous Mutual-Interest-Based Social Introduction System

(76) Inventors: Barton Baldwin, Newport, RI (US); Lee Weinstein, Arlington, MA (US); Andrew Reilly, Middletown, RI (US)

(21) Appl. No.: 13/172,879

(22) Filed: Jun. 30, 2011

Related U.S. Application Data
(60) Provisional application No. 61/360,688, filed on Jul. 1, 2010.

(51) Int. Cl. G06Q 99/00; G06Q 30/00; G06F 15/16

(52) U.S. Cl. 705/26.1; 709/204

(57) ABSTRACT

An web-based anonymous mutual-interest-based social introduction system allows registered users to anonymously express interest in a friends or acquaintances by specifying the e-mail address and/or mobile phone number of each person of interest. Interest is recorded in a database and if a person in whom interest was expressed independently expresses a mutual interest, both parties are notified. In a preferred embodiment, users expressing interest may choose to have enticing clues sent to the person of interest to encourage him or her to register with the system and anonymously express interest in friends and/or acquaintances. Unlike typical dating websites, the present invention is meant to facilitate dating between persons who have met but not yet disclosed attraction to one another.

### CROSS-REFERENCE TO RELATED PATENT APPLICATIONS

This patent application claims priority to U.S. provisional patent application No. 61/360,688, which is herein incorporated by reference.

### FIELD OF THE INVENTION

The field of the invention relates to internet dating, social introduction services, social networking, and more specifically to anonymous on-line introduction services.

### BACKGROUND OF THE INVENTION

One of the major benefits of the internet has been the extent to which it has facilitated innovations in social interaction and social networking Even in the early days of the internet, dating websites sprang into being which offered participants a wide variety of possible new people to interact with. Revenue models of internet dating websites have evolved over time. Some (like Yahoo Singles) were free in the beginning, and switched to a paid membership model after building a sufficiently large customer base. Others (such as Match.com) adopted a pay-for-membership model earlier. Some (like OKCupid.com, PlentyOfFish.com, and CraigsList.com) still have no membership fees.

All of the internet dating websites listed above are chiefly designed to offer several benefits:

A large variety of on-line profiles of men and women a customer does not know may be pursued.

Messages may be sent to persons of interest in a privacy-assured manner (the recipient can access the sender's profile information, but that information need not include “real-world” identity of contact information).

Profiles may be searched for persons fitting specific desired criteria, such as age range, geographic location, religion, race, political affiliation, job type, etc.

Each member who posts a profile may receive messages of interest from potential suitors.

The interests of an internet dating website and the interests of its members do not always align. Depending on how popular a person's profile is with potential suitors, the experience of using an internet dating website (and the effects of the policies of that internet dating website) can be quite different. For instance, an average looking man interested in meeting women might get a few inquiries per month from women, whereas an attractive woman seeking a man might get 100 inquiries per day from men. Many popular users have found that after they stop paying the fee for their profiles, internet dating websites such as Match.com leave those profiles “active” even though no fees are being paid. From the point of view of the internet dating website, the more active profiles it has, the more potential choice it appears to offer to potential members choosing between internet dating websites. Moreover, from the point of view of an internet dating website, the higher the fraction of “attractive” users it has as members, the more likely it will be chosen as the preferred service to pay for when consumers shop for an internet dating website to join.

Some attractive women have found it difficult or impossible to have their profiles removed from Match.com after they took steps to terminate their membership. While Match.com claims it is a “benefit” that these women still receive inquiries from suitors, many women do not see this as a benefit. There is a need for innovations in the realm of internet-based services that facilitate relationships, such that the social interests of users and the financial interests of internet social introduction services are more closely aligned.

To entice “desirable” men and women to join, Chemistry.com goes further than most internet dating websites in the direction of ensuring users receive less unwanted inbound communication. Chemistry.com does this in part by limiting to a computer-chosen subset the potential members who may be contacted. Chemistry.com goes further to protect users from unwanted inbound communication, by forcing users to go through a sequence of sequentially less communication-restricting steps, which end in users being able to send unrestricted messages to each other. While the policies of Chemistry.com succeed in limiting the volume of inbound messages that popular members receive, there are certainly cases when the questions that Chemistry.com asks its members, and the matching algorithm that is used to process the answers to those questions and select potential matches to members, are inadequate to predict what might be a great match if two users actually happened to meet each other and begin talking There is a need for innovations in the realm of internet-based services that facilitate relationships, such that matches that are suggested automatically are more likely to be experienced as desirable matches by both parties.

While typical on-line dating websites offer some privacy prior to the exchange of direct contact information, the posting of photographs has the potential to limit privacy in a broad way. For instance, a shy person may want to be able to post an on-line profile which exposes dreams and desires usually kept private, but if a real photo is posted as part of his or her profile, many people that already know him or her (for instance at school or work or church) may see the profile and suddenly learn things the person posting the profile did not want prior acquaintances to know. There is a need for innovations in the realm of internet-based services that facilitate relationships, such that users can better keep things private from people they don't want to date.

While internet dating websites provide a means for people to meet a wide variety of people they do not yet know, they do little to facilitate the development of fulfilling relationships between people who have already met. For instance suppose John goes to his 10th college reunion and finally gets up the nerve to tell Suzie that he was in love with her in college and never made a move. Suzie responds that she really wanted John to ask her out bet he never did. There is a need for innovations in the realm of internet-based services that facilitate the development of fulfilling relationships between secretly mutually attracted people who have already met.

### SUMMARY OF THE INVENTION

In one aspect, the present invention facilitates the disclosure of mutual attraction between two people in situations where it may exist in secret, in that the attraction of each person to the other is not known to the other, though mutual attraction is in fact present. It is an object of the present invention to provide an internet-based system which facilitates relationships, such that the social interests of users and the financial interests of internet social introduction services are closely aligned. It is a further object of the present invention to provide an internet-based service that facilitates relationships, such that matches that are suggested are automatically extremely likely to be experienced as desirable matches by both parties. It is a further object of the present invention to provide an internet-based service that facilitates relationships, such that users can better keep things private from people they don't want to date. It is a further object of the present invention to provide an internet-based service that facilitates the development of fulfilling relationships between people who have already met and been attracted to each other, but who have kept the attraction they felt secret from one another.

Some aspects of a preferred embodiment of the present invention can be seen in the following example in which social interaction between John and Mary is facilitated by the present invention in an internet-based embodiment which may be referred to in this document as Pingsby. Suppose John and Mary each know each other at work. John is attracted to Mary and would like to go out with her, but he fears that if he asks her out and she says no, he will feel embarrassed and rejected and will be uncomfortable around her after that. He may also fear that if he asks her out and she says yes, but she feels it is just a platonic date and he thinks it is a romantic date, they might be even more uncomfortable around each other at work after that. Now let us also assume that Mary is attracted to John, but she has similar fears, so she does not communicate her attraction to him.

The features of the present invention are ideally suited to solve John and Mary's dilemma. Assuming John knows Mary's e-mail address or phone number, utilizing the present invention, John simply creates an account on the Pingsby website, and indicates his interest in Mary, identifying her by her phone number or e-mail address. Such an indication of interest in one person on the part of another shall be referred to in this document as a ping″. John's ping of Mary is kept confidential in the Pingsby database unless Mary has previously pinged John. If Mary also creates an account on the Pingsby website and enters a ping to John, the present invention detects that John and Mary have each expressed interest in dating each other, and the present invention automatically contacts both john and Mary and lets each know of the interest they have in each other. Thus the present invention allows people with a mutual interest in dating each other to find out about that mutual interest without risk of rejection, while automatically keeping confidential “one way” romantic interests. Within this document, the mutual expression of interest by two persons in participating in the same activity with each other will sometimes be referred to as a “cross ping”.

In a preferred embodiment, persons registering for Pingsby accounts can voluntarily register as many unique contact addresses as they have (for instance: personal e-mail address, work e-mail address, home phone number, work phone number, instant messenger ID, name and address, etc.).

Since people may have different types of interest in one another, a preferred embodiment of the present invention also allows people to specify the type of interest they have in another person. For instance, suppose John and Mary are each in a relationship, and they don't want to leave the relationships they are in, but they have a mutual attraction and want to have a fling. John can enter a “fling” interest in Mary in his Pingsby account according to the present invention. A statement of interest for a particular purpose shall be referred to in this document as a ping for that purpose, so in the above example, John has entered a “ping for a fling” for Mary.

If Mary enters a ping for a long-term relationship with John and John has entered a ping for a fling with Mary, both pings are kept confidential. If John enters a ping for a platonic date with Mary and Mary enters a ping for a fling with John, both pings are kept confidential. If john enters a ping for a fling with Mary and Mary enters a ping for a fling with John, the present invention contacts both Mary and John automatically and informs each of the mutual interest.

In a preferred embodiment, different types of interest may be overlapping though not identical. For instance, if John pings Mary for a date, and Mary pings John for a fling, these two pings may be defined as overlapping though not identical, and both John and Mary would be automatically informed of the other's interest. In a preferred embodiment, in such a case, the person with the “more aggressive” interest would be informed that the other person had a less aggressive interest. For instance in this case John might be informed that Mary was interested in a date with him. John would then know not to assume that Mary was already interested in a fling.

In a preferred embodiment, in order to avoid counting an undesired overlap as a match, the present invention also allows the statements of disinterest (negative pings), concerning certain activities. For instance, if Mary pings John for a date and negatively pings john for a fling, then if John pings Mary for a fling only, then the two pings will not match or overlap, and will be kept confidential.

In a preferred embodiment, areas of interest that overlap are presented graphically in the form of a Venn diagram, where different areas of the diagram can be click-selected with a mouse or similar point-and-click device.

In a preferred embodiment, several aspects of the present invention encourage the growth of membership. These aspects shall be referred to collectively in this document as viral aspects of the present invention. A first viral aspect of a preferred embodiment of the present invention is that when a person creates an account and pings someone (for instance by entering an e-mail address), the pinged person receives an e-mail saying that someone has expressed interest in them through Pingsby.com. The e-mail invites the pinged person to join Pingsby, and express interest in (ping) others according to the present invention.

In a second viral aspect, in a preferred embodiment of the present invention, a person pinging someone may choose to enter clues to his or her identity, to entice the pinged person to join Pingsby and enter pings for persons he or she is interested in meeting. In a preferred embodiment, a sequence of progressively more specific clues may be provided. In a preferred embodiment, these clues are sent as e-mails or text messages, and preferably presented in such a way as to rouse curiosity enough that the person receiving the clues will not consider them unwanted communication. For instance John may ping Mary and provide a first clue “Someone at work is interested in you”. A second clue might be “you talked to this person at the company party last year”. A third clue might be “this person once had lunch with the queen of England”.

In a third viral aspect, a preferred embodiment of the present invention allows people to become members and receive information that they have been pinged at no charge, provided they express interest in (ping) a specified minimum number of people according to the present invention.

In a preferred embodiment, when a person has joined Pingsby and has provided an e-mail address, he or she receives a confirmation e-mail, specifying an action that must be taken in order to confirm that the e-mail address should indeed be linked to the Pingsby account in which it is listed as an e-mail address for the account owner. Likewise, when a person has joined Pingsby and provided a contact phone number, a confirmation phone call is made to that number and a message is played describing an action to be taken to confirm that that phone number should be linked to the Pingsby account in which it is listed as a phone number of the account owner.

Within this document, the process of a Pingsby member pinging a non-member, and that non-member subsequently registering and verifying his or her contact information shall be referred to as generating a referral.

In a third viral aspect of a preferred embodiment of the present invention, when two Pingsby members who have each generated less than a predetermined number of referrals generate a cross ping, those Pingsby members are contacted automatically and each told that they received a ping which could be a cross ping, and in order to find out, either a fee must be paid, or the specified minimum number of referrals must be completed. If either of them generates the minimum number of referrals before paying a membership fee, then that person will be informed that indeed a cross ping has occurred, and that a per-ping fee must be paid to find out the identity of the person with whom the cross ping occurred.

Once one of the two members with mutual interest (crossed pings) pays either a membership fee or a per-ping fee, both members are automatically notified of the cross-ping, and both learn the identity of the person they are interested in who is interested in them.

### BRIEF DESCRIPTION OF THE DRAWINGS

FIG. 1 is a flow chart of actions taken (both manual, automatic, and mixed) and decisions made (some manual and some automatic), in the operation of a preferred embodiment of the present invention.

FIG. 2 is a block diagram of the hardware of a preferred embodiment of the present invention.

FIG. 3 is an example user registration page served to a first-time user by the web server of a preferred embodiment of the present invention.

FIG. 4 is an example initial ping management page shown after login to the website of a preferred embodiment of the present invention.

FIG. 5 depicts example menus from which a user may select identity clues to be sent to a person of interest as pings in a preferred embodiment of the present invention.

### DETAILED DESCRIPTIONS OF SOME PREFERRED EMBODIMENTS

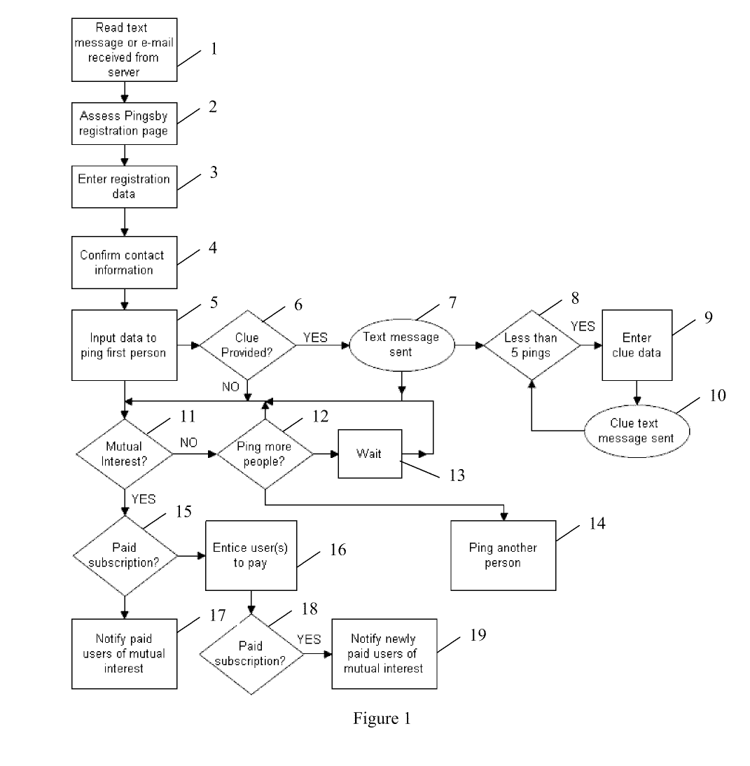

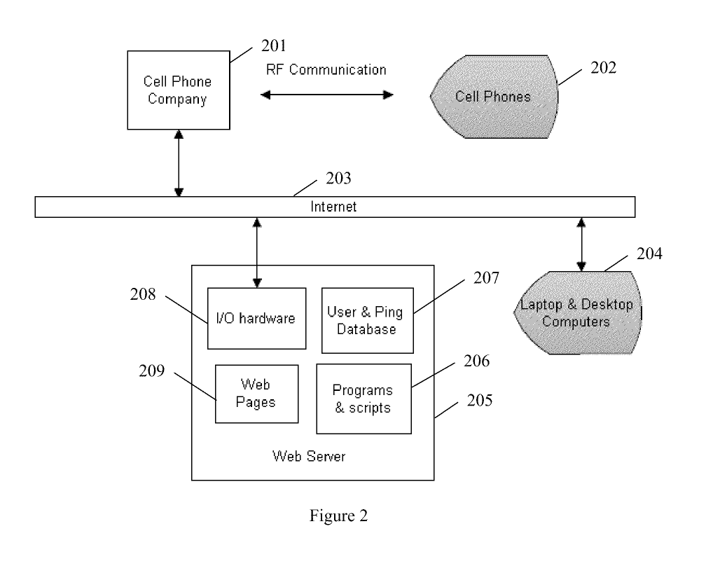

FIG. 1 is a flow chart of actions taken (both manual, automatic, and mixed) and decisions made (some manual and some automatic), in the operation of a preferred embodiment of the present invention. Prior to step one in FIG. 1 it is assumed that the present invention (which may herein be referred to as the Pingsby system) is operating, and that at least one user has registered and pinged a “target” person by sending a text message to the cell phone of the target person, or an e-mail ping to an e-mail address of that person. In step one, the target person receives a text message or e-mail ping, which requests that the target person register at the Pingsby website.

Within this document, it shall be assumed that text messages and e-mails are functionally equivalent, with the exception that text messages are not hypertext and therefore cannot contain “clickable” links, and thus any URL contained within a text message may need to be hand-typed into a browser to access the webpage to which the URL points. While it is assumed that text messages and e-mail messages are functionally equivalent, it is recognized that the sending of text messages may be subject to different legislation than the sending of e-mail messages, and thus the sending of text and e-mail messages may be legally distinct. Reference within this document to sending a text message may be construed as reference to sending a text and/or e-mail message, and reference within this document to sending an e-mail message may be construed as reference to sending a text and/or e-mail message. It may be assumed that in a preferred embodiment of the present invention, if the sending of an e-mail message would be restricted by legislation and the sending of a text message would not, then a text message would be sent, and vice versa.

In step one of FIG. 1, the target person receives a ping (in the form of a text or e-mail message or phone call). In a preferred embodiment, that ping may include a statement that an acquaintance or friend of the target person is attracted to the target person. In a preferred embodiment the ping also includes an invitation to register as a user of the Pingsby website. In step two of FIG. 1 the target person accesses the registration page of the Pingsby website. This may be done through a web browser on a laptop or desktop computer, or through a web-enabled smart phone or the like. In a preferred embodiment, the Pingsby website may be accessed either by typing a URL into a browser or by clicking a hyperlink in the Ping message which was received.

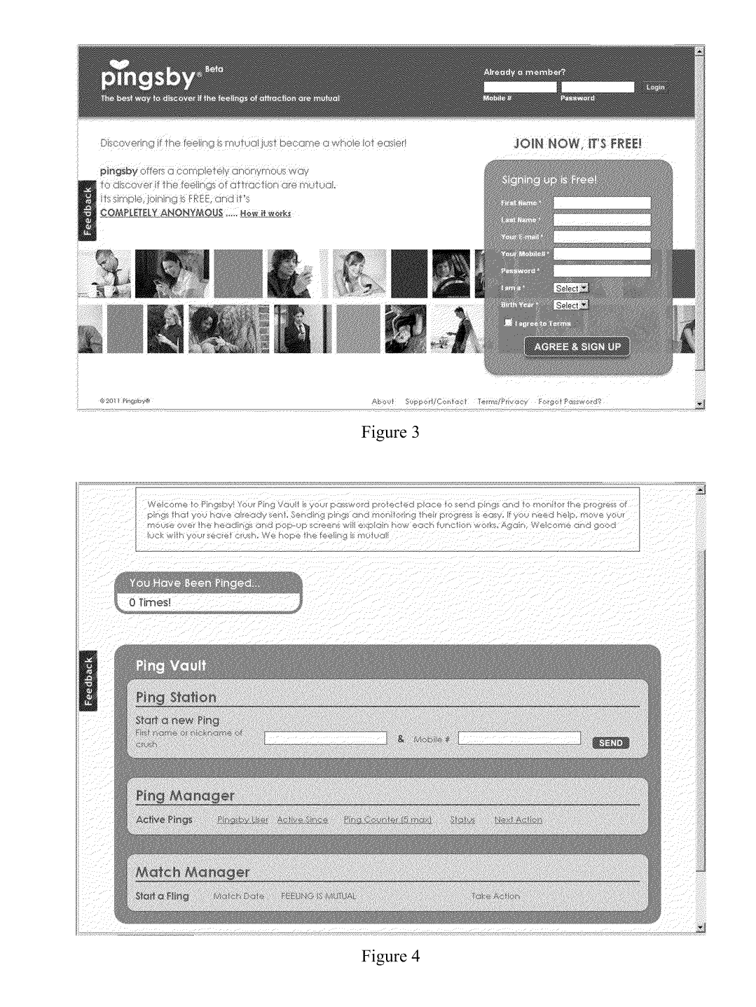

In step three of FIG. 1 the target person enters registration data into the registration page of the Pingsby website. An example user registration page of a preferred embodiment of the present invention is shown in FIG. 3. In a preferred embodiment, registration information includes first name, last name, e-mail address, mobile phone number, password, gender, birth year, and a checkbox to indicate agreement with terms of use.

In step four of FIG. 1, in a preferred embodiment, both the e-mail address and mobile phone number provided by the target person are verified as belonging to the target person. In a preferred embodiment that verification takes place by a verification e-mail automatically being sent by the present invention to the e-mail address provided by the target person. In a preferred embodiment, that verification e-mail contains a clickable link, which, when clicked, accesses a URL, the accessing of which verifies that the e-mail address belongs to the target person. In a preferred embodiment, a verification text message is sent to the mobile phone number provided by the target user with instructions to reply with a given code to verify that the phone to which the text message was sent belongs to the target user. In an alternate embodiment, a phone call is placed to the phone number, and an interactive voice response (IVR) system prompts the person answering the phone to confirm that he or she just registered at the Pingsby website.

In a preferred embodiment, after the above verification of e-mail address and phone number, in step five of FIG. 1, the present invention displays for the target user a ping management webpage such as the ping management webpage depicted in FIG. 4. When accessing the ping management webpage of the present invention for the first time, in a preferred embodiment of the present invention, the target user is presented with a text and/or audio message, inviting the target user to enter one or more pings for people the target user is attracted to. In a preferred embodiment, for each ping entered, a user types the first name or neck name of the person of interest, and that person's mobile phone number and/or e-mail address. The user then clicks the send button, and the fact that the user is interested in a person identified by the mobile phone number and/or e-mail address given is recorded in the database of the present invention.

In a preferred embodiment, a user sending a ping may be given an opportunity to specify a clue to be sent to the person of interest by e-mail or text message, giving a clue to the identity of the interested person to entice the person of interest to register at the Pingsby website and ping persons who are of interest to the person of interest. For example, a man might ping a woman and tell her he became interested in her at the company Christmas party, or he might ping her and say he wants to take her on an adventure vacation he is planning. Either ping might arouse curiosity and have her register with the website of the present invention and ping men who she hopes were the source of the anonymous ping she received.

If a clue is provided in step 6 of FIG. 1, then a text message and or e-mail message is sent to the person of interest in step 7 of FIG. 1. If a clue is not provided, then in a preferred embodiment of the present invention no communication is sent to the person of interest regarding the interested person unless the person of interest later registers at the Pingsby website and expresses a mutual interest by setting up a ping.

In an alternate preferred embodiment, specifying a person of interest in an initial ping without providing an identity clue may result in the apparatus of the present invention sending a single text and/or e-mail message to the person of interest, stating that someone has expressed interest in that person through the Pingsby system, and inviting that person to register with the Pingsby system and express previously unexpressed interests in other persons through the Pingsby system.

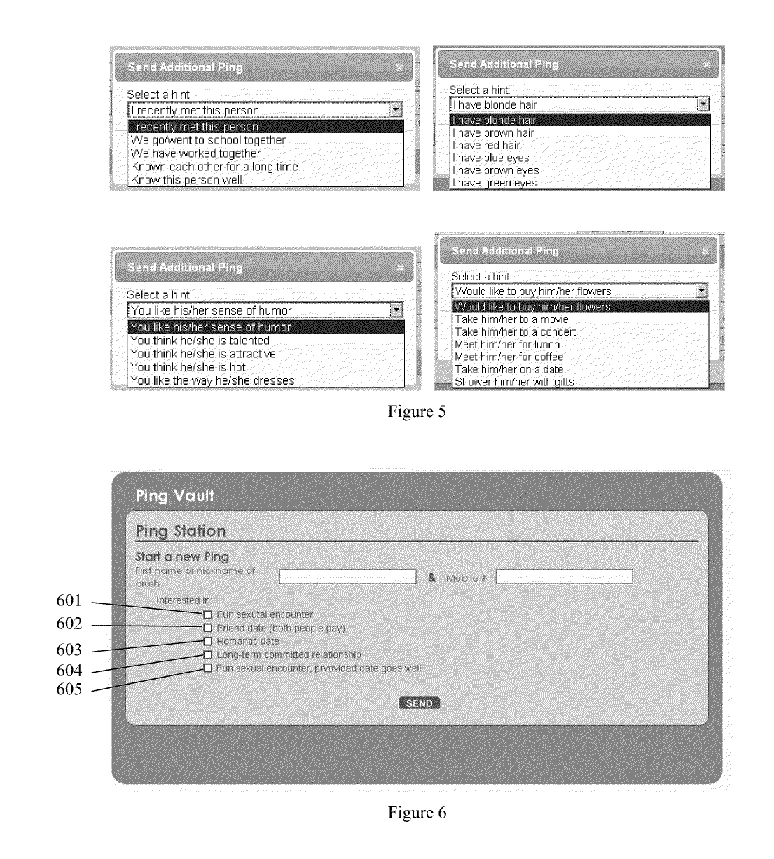

In a preferred embodiment, once interest in a given person has been expressed by setting up an initial ping, up to a total of five text message and/or e-mail message clues may be sent to the person of interest through the Pingsby system by the interested person (see steps 8, 9, and 10 of FIG. 1). In a preferred embodiment, clues may either be typed by the user, or selected from menus such as those depicted in FIG. 5.

In a preferred embodiment, each time interest is expressed in an individual (identified by a phone number, e-mail address, or both), the present invention automatically checks to see if a mutual interest exists (step 11 of FIG. 1). In a simple preferred embodiment, interest is a simple binary function (interested or not interested). IN a more complex preferred embodiment, interest may be expressed as an array of binary values representing desires, or as an array of conditional desires. FIG. 6 depicts a screen allowing a user to express an array of binary desires (one of which is conditional) regarding another user, and to store that array confidentially by “sending” the ping. If no identity clue is provided, nothing is actually sent to the person of interest unless and until a mutual interest is expressed by that person.

The array of interests depicted in FIG. 6 are “Fun sexual encounter” (601), “Friend date (both people pay)” (602), “Romantic date” (603), “Long-term committed relationship” (604), and “Fun sexual encounter, provided date goes well” (605). If two users ping each other, by each filling out the interest array (checkboxes 601 through 605) and clicking “send”, then a match will occur if any of the following occur:

Both users click checkbox 601

Both users click checkbox 602

Both users click checkbox 603

Both users click checkbox 604

Both users click checkbox 605

In a preferred embodiment, when a match occurs, both users will be informed (provided they have paid the required fee) of the matching checkboxes, and the other checkboxes will be kept confidential, with exceptions in this example if one user checked box 601 and the other checked box 605. In this case, both users will be informed of a conditional match regarding box 601 and box 605.

If a mutual interest exists, the present invention automatically checks to see if one or both persons who are interested in each other have a “paid subscription” to the present invention. Any person who already has a paid subscription is immediately automatically notified of the mutual interest in step 17 of FIG. 1. Automatic notification may take place by a phone call on which an audio message is played, or automatic notification may take place via e-mail or text message or IVR phone call In a preferred embodiment, any person involved in the mutual interest who does not have a paid subscription will automatically be contacted (step 16 of FIG. 1) with the message designed to entice that individual to upgrade to a paid subscription. If users subsequently pay, they will be notified automatically (steps 18, 19 of FIG. 1) of the mutual interest.

In a preferred embodiment, a subscription may be paid for in cash (via credit card, PayPal, etc.) or maybe paid for in services, for instance by enticing a predetermined number of new members to register with the Web server of the present invention, verify their contact information, and possibly also enter at least one ping. This method of paying for membership by registering additional individuals increases the potential for word of the present invention to spread virally, and it is likely that the potential value perceived by new users in registering with the present invention will grow with the number of persons already registered with the present invention.

FIG. 4 is an example initial ping management web page shown after login to the website of a preferred embodiment of the present invention. In a preferred embodiment, various help text appears when a user hovers a graphical pointer over the text segments listed below:

Hovering over “Start a new Ping” brings up the help text “Send your secret crush their first ping from the Ping Station. This will initiate an active ping sequence in the Ping Manager below. You will then be able to send additional pings and hints to your secret crush.”

Hovering over “Pingsby User” brings up the help text “This tells you if this person is a registered Pingsby user.”

Hovering over “Active Since” brings up the help text “This tells you how long it has been since you sent your target the first anonymous ping.”

Hovering over “Ping Counter (5 max)” brings up the help text “Pingsby allows you to send up to 5 pings to your target. Each ping will be anonymous and may be sent with a small hint to help your target identify something about you without revealing your identity.”

Hovering over “Status” brings up the help text “The status of pings stays open for as long as you want it to. Your target may take as long as they want to discover that you are their target too, and that results in mutual attraction match! It is recommended that you leave pings active as long as you hope your target has mutual feelings for you. If for some reason your feelings change however, you may suspend a ping by disabling it. This way if your target enters you as a target, there will NOT be a mutual attraction match.”

Hovering over “Next Action” brings up the help text “Pingsby does not allow you to stalk your target. We throttle the number of time you can ping your target so that you don't become annoying and turn your target off. The Next Action area will tell you when you are able to send your next ping by telling you “Send your next Ping NOW! Click on NOW!” And this will activate your next ping sequence.”

In a preferred embodiment, means allowing a plurality of individuals to register and provide unique personal contact information may comprise a web server connected over the internet to a laptop computer, desktop computer, PDA, cell phone, or the like, or may comprise a phone server with an interactive voice response (IVR) system, connected to the public switched telephone network (PSTN), where the web server or IVR server is programmed to set up password-protected user accounts when supplied with required information by a user.

In a preferred embodiment, means allowing a first individual to confidentially express a first interest in a second individual may comprise a web server connected over the internet to a laptop computer, desktop computer, PDA, cell phone, or the like, or may comprise a phone server with an interactive voice response (IVR) system, connected to the public switched telephone network (PSTN), where the web server or IVR server is programmed to prompt a user to enter identifying data about a person of interest.

In a preferred embodiment, means for automatically notifying an individual that a mutual interest has been detected may include means for automatically contacting the individual by phone and playing a recorded or synthesized audio message (live or onto voice mail), means for sending an e-mail to the individual, means for sending a text message to the individual, or some combination of such means.

Within this document, the “relating to a person” shall be deemed synonymous with “interacting with a person. Example ways in which two people could be interested in relating to (interacting with) each other include but ate not limited to: participating in an activity (dinner, movie, walk, skydiving, camping, traveling, sex, cuddling, making out, fondling, mountain climbing, hiking, kayaking, skiing, etc.) together, or being in a type of relationship (long-term committed, sex-buddy, cuddle buddy, polyamorous, etc.) together.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. A mutual interest detection and disclosure system comprising:
means allowing a plurality of individuals to register and provide unique personal contact information,
means allowing a first individual to confidentially express a first interest in a second individual,
means for storing in a confidential database said expressed first interest,
means for allowing a second individual to express second interest in a third individual,
means for automatically detecting when said third individual and said first individual are the same individual, and when said first interest and said second interest constitute a mutual interest, and
automatic notifying means for automatically notifying at least one of said first and second individuals that a mutual interest has been detected.

2. The mutual interest detection and disclosure system of claim 1, wherein said automatic notification means comprises:
means for notifying said first and said second individual that a mutual interest may exist and that a fee must be paid to find out whether a mutual interest exists,
means for accepting payment of a fee from said first or second individual, and
means for automatically contacting said first individual and disclosing to said first individual the identity and mutual interest of said second individual after said fee is paid by said first individual.

3. The mutual interest detection and disclosure system of claim 1, wherein said first interest comprises an interest in relating to one another in a particular way.

4. The mutual interest detection and disclosure system of claim 4, wherein said particular way is selected from a predetermined list of possible ways.

5. The mutual interest detection and disclosure system of claim 1, wherein said first interest comprises an interest in participating with one another in a specified activity.

6. The mutual interest detection and disclosure system of claim 1, further comprising means for automatically verifying said unique personal contact information.
